(19) United States
(12) Patent Application Publication
(10) Pub. No.: US 2006/0242395 A1
(43) Pub. Date: Oct. 26, 2006

(54) Operating system boot from network location

(75) Inventor: Andrew T. Fausak, San Jose, CA (US)

Correspondence Address: MCDERMOTT WILL & EMERY LLP, 18191 VON KARMAN AVE., SUITE 500, IRVINE, CA, 92612-7108, US

(73) Assignee: Wyse Technology Inc., San Jose, CA (US)

(21) Appl. No.: 11/074,875

(22) Filed: Mar. 9, 2005

(51) Int. Cl. G06F 9/00

(52) U.S. Cl. 713/1

(57) ABSTRACT

The present invention provides a system for booting an intelligent device with an embedded-type operating system obtained through an external interface disposed in the intelligent device, wherein the system includes an initialization module stored in a read-only memory provided in the intelligent device, the initialization module being executed in a processor disposed in the intelligent device and connecting to an external location through the external interface, and a server having a memory media which stores a boot agent module and an embedded-type operating system at the external location, the server sending the boot agent module to the intelligent device through the connection in response to a request from the initialization module, wherein the boot agent module is loaded into a runtime memory in the intelligent device and executed by the processor, the boot agent module then retrieving an embedded-type operating system image from the external location in the sever, whereupon the embedded-type operating system image is loaded into the runtime memory and executed by the processor.

### RELATED APPLICATION

This application is related to U.S. patent application Ser. No. ______, filed on ______, entitled “Operating System Boot From External Media”.

### BACKGROUND OF THE INVENTION

1. Field of the Invention

The present invention relates generally to booting a limited-resource computing device, also known as an intelligent device, with an embedded-type operating system obtained over a data connection.

2. Description of the Related Art

The use of intelligent devices continues to grow in popularity. These intelligent devices include enterprise tools such as industrial controllers, communications hubs, thin client devices, and point-of-sale terminals as well as consumer products such as cameras, smart mobile phones, media devices, and home entertainment devices. These intelligent devices typically have limited resources as compared to a typical PC-type computing device. For example, an intelligent device may have a limited-size hard disk or other type of permanent memory.

Typically, such intelligent devices contain a processor that executes an embedded-type operating system (OS), such as Microsoft Windows XP Embedded or Microsoft Windows CE, although other embedded-type operating systems are also used. In addition, many of these intelligent devices also have an external interface capability such as a networking capability or another known type of connection such as a USB connection, a FireWire 1334 connection, and the like.

Conventional intelligent devices operate by booting the embedded-type OS from a memory media provided in the intelligent device. For example, a small hard disk or persistent read-only memory (ROM) is used to store the embedded-type OS. The initialization boot process then accesses the embedded-type OS from the local memory media and loads the operating system components, such as the kernel and related files, into random access memory for execution by the processor. Embedded-type operating systems usually have specific pre-defined requirements for loading the components of the embedded-type OS into RAM, and these requirements must be complied with to ensure proper boot and operation of the embedded-type OS.

As the footprint and weight of intelligent devices becomes smaller, it is desirable to further limit the resources provided in the intelligent device. However, resource constraints are driven by the requirement to provide some form of persistent memory in the intelligent device with sufficient space to store the embedded-type operating system. Also, the embedded-type operating system provided in an intelligent device is difficult to update and manage without substantial intervention by the user of the intelligent device.

Accordingly, it is desirable to develop an intelligent device that does not locally store an operating system in persistent memory, but instead loads and boots an “embedded-type” OS from a remote location via an external interface, such as a data network.

### SUMMARY OF THE INVENTION

The present invention addresses the foregoing need by providing a method for loading and booting an “embedded-type” OS onto an intelligent device from a remote location via an external interface, such as a data network.

According to one aspect of the invention, the present invention is directed to a system for booting an intelligent device with an embedded-type operating system obtained through an external interface disposed in the intelligent device, wherein the system includes an initialization module stored in a read-only memory provided in the intelligent device, the initialization module being executed in a processor disposed in the intelligent device and connecting to an external location through the external interface, and a server having a memory media which stores a boot agent module and an embedded-type operating system at the external location, the server sending the boot agent module to the intelligent device through the connection in response to a request from the initialization module, wherein the boot agent module is loaded into a runtime memory in the intelligent device and executed by the processor, the boot agent module then retrieving an embedded-type operating system image from the external location in the sever, whereupon the embedded-type operating system image is loaded into the runtime memory and executed by the processor.

According to another aspect of the invention, the present invention is a method for booting an intelligent device with an embedded-type operating system obtained through an external interface disposed in the intelligent device, by establishing a connection through the external interface to an external location in a server, the server having a memory media which stores a boot agent module and an embedded-type operating system at the external location, receiving the boot agent module from the server via the connection in response to a request from an initialization module being executed by a processor in the intelligent device, loading the boot agent module into a runtime memory in the intelligent device and executing the boot agent module with the processor, receiving, in response to a request from the boot agent module, the embedded-type operating system image from the sever via the connection, and loading the embedded-type operating system image into the runtime memory and executing the embedded-type operating system image with the processor.

The external interface is preferably a network interface to a data network, and the initialization module preferably implements a pre-boot execution environment that issues DHCP requests to obtain network configuration information and connection information from the server in order to establish the connection with the external location in the server. The boot agent module and the embedded-type operating system image are preferably retrieved from the server via a standard connection protocol, such as the internet protocol. Also, the embedded-type operating system image is preferably unpacked in accordance with a predetermined rule set, and sub-portions of the unpacked kernel archive are written to predetermined locations in the runtime memory of the intelligent device. An initialization record is preferably used to pass a set of arguments and run-time variables to the kernel archive for a proper boot in the intelligent device.

In this manner, the present invention allows an intelligent device to boot an embedded-type operating system, such as Windows CE, from a remote location via a network interface, or other data interface, thereby avoiding the need for the intelligent device to have sufficient local memory space to persistently store the operating system. This allows intelligent devices to achieve design and cost savings with respect to the local memory resources and the footprint of the intelligent device. In addition, updates and improvements to the embedded-type operating system are more easily be managed and stored in the server, for automatic implementation in the intelligent device at boot-up of the device.

Other and further objects and advantages of the present invention will be further understood and appreciated by those skilled in the art by reference to the following specification, claims, and drawings.

### BRIEF DESCRIPTION OF THE DRAWINGS

FIG. 1 is a schematic diagram depicting a network environment in which the invention may be practiced according to one embodiment of the present invention.

FIG. 2 is a block diagram for illustrating the internal architecture of an intelligent device and a server according to according to one embodiment of the present invention.

FIG. 3 is a block diagram for illustrating the contents of the read-only memory of the intelligent device depicted in FIG. 2.

FIG. 4 is a block diagram for illustrating the contents of the hard disk drive of the server depicted in FIG. 2.

FIG. 5 is a flowchart for explaining the boot of an embedded-type operating system in an intelligent device via a network connection according to one embodiment of the present invention.

### DETAILED DESCRIPTION OF THE INVENTION

As mentioned above, the present invention is generally directed to the loading and booting of an “embedded-type” OS in an intelligent device from a remote location in a server via an external interface, such as a data network.

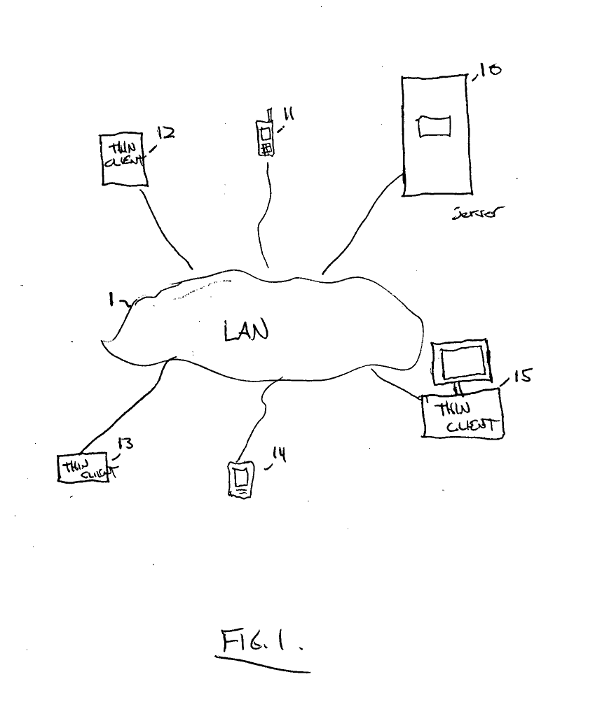

FIG. 1 provides a depiction of a network environment in which the invention may be practiced, although other types of connections can be used between the intelligent device and the server. As seen in FIG. 1, there is provided large area network (LAN) 1, sever 10 and intelligent devices 11 to 15. In this regard, the intelligent devices shown in FIG. 1 include thin clients 12, 13 and 15, smart phone 11, and personal digital assistant (PDA) 14. These types of intelligent devices are shown in FIG. 1 for the sake of example, but it should be appreciated that the present invention works with any type of device that contains a processor and utilizes an embedded-type operating system such as Microsoft Windows CE or Windows XP Embedded. Typically, such devices have limited persistent memory resources and utilize an embedded operating system for memory and processor efficiency. In this manner, intelligent devices can provide the user with sophisticated functionality in a compact design and lower cost than a conventional PC-type device.

As mentioned above, intelligent devices can include industrial controllers, communications hubs, thin client devices, and point-of-sale terminals, as well as consumer products such as cameras, smart mobile phones, media player devices, and home entertainment devices. Of course, intelligent devices include other types of devices that have a processor and limited memory resources. Returning to FIG. 1, LAN 1 is used to provide a data network connection space through which a device can communicate with one or more other devices. LAN 1 is a typical network interface which supports known connection protocols, such as TCP, IP, DHCP, etc. As mentioned above, other types of connections can be used to implement the present invention, such as universal serial bus (USB), FireWire, etc. Smart phone 11 and PDA 14 communicate with LAN 1 through wireless or hardwire network connections, and provide the user with the capability of running various applications. Thin clients 12, 13 and 15 are computing devices with limited resources that are configured to support specific functionality. For example, thin clients 12 and 13 could be industrial devices which monitor and report on industrial processes via a network connection, either hardwire or wireless, and thin client 15 is configured as a user terminal in a business networked computing environment.

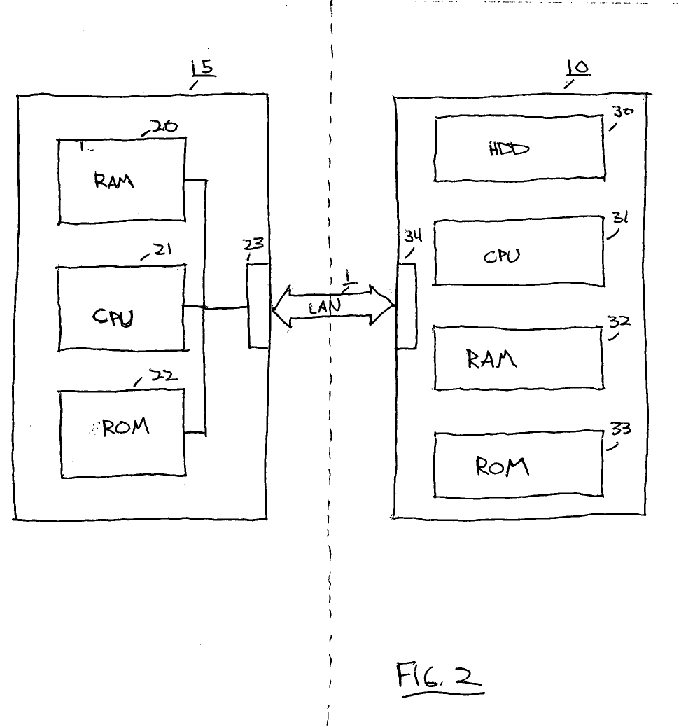

FIG. 2 depicts the internal architecture of the system components for implementing the present invention according to one example which includes thin client 15 and server 10. As seen in FIG. 2, thin client 15 and server 10 are able to communicate with each other via LAN 1. Thin client 15 is seen to include random access (runtime) memory (RAM) 20, central processing unit (CPU) 21, read-only (persistent) memory 22, and external interface 23, all of which communicate internally via a bus. RAM 20 is used to load executable code for access by CPU 21 for execution. ROM 22 is a limited-size memory that is used to store a minimal amount of data on a persistent basis. With the present invention, ROM 22 does not need to be large enough to store an operating system, since the operating system is retrieved from an external location via external interface 23, as discussed more fully below. The contents of ROM 22 are discussed in more detail below.

External interface 23 shown in FIG. 2 is a network interface for communication via LAN 1, and is either a wireless or hardwire interface. Of course, the invention may be used with other types of connections, such as USB or FireWire, and therefore external interface 23 would instead be an appropriate type of interface for the subject connection.

Turning to the depiction of server 10 in FIG. 2, it is seen that server 10 includes hard disk drive 30, CPU 31, RAM 32, ROM 33 and external interface. Server 10 is a typical server with sufficient hardware resources to be self-sustaining and to support requests from clients over LAN 1. In this regard, hard disk drive 10 is of sufficient size to store an operating system, application programs, and data files. The contents of hard disk drive 30 are discussed in more detail below. RAM 32 is a runtime memory to store executable code for access and execution by CPU 31, and ROM 33 is a read-only persistent memory for storing executable code, such as initialization routines.

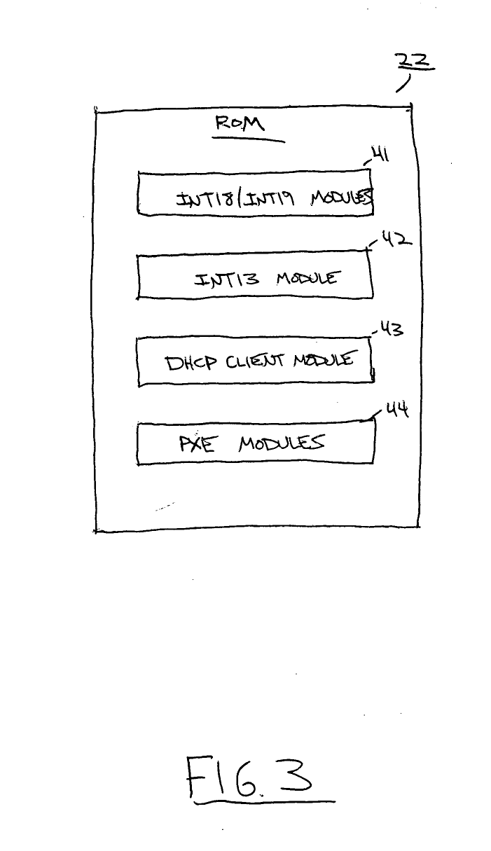

Turning to FIG. 3, the contents of ROM 22 are depicted in more detail. Included in ROM 22 are INT18/INT19 modules 41, INT13 module 42, DHCP client module 43 and PXE modules 44. INT18/INT19 modules 41 are initialization programs that are executed at start-up of intelligent device 15, and which are used to initiate the functionality of the present invention, as discussed in more detail below. INT13 module 42 is an initialization level program used to read data from a specified location, and is called from INT18/INT19 modules 41, as discussed further below. DHCP client module 43 is a dynamic host configuration protocol (DHCP) client that is executed during start-up of intelligent device 15 to obtain network information, such as a dynamic IP address, from server 10 for configuring external interface 23 of intelligent device 15. PXE modules 44 are a set of routines that comprise a pre-boot execution environment to support functions required for pre-boot configuration and initialization.

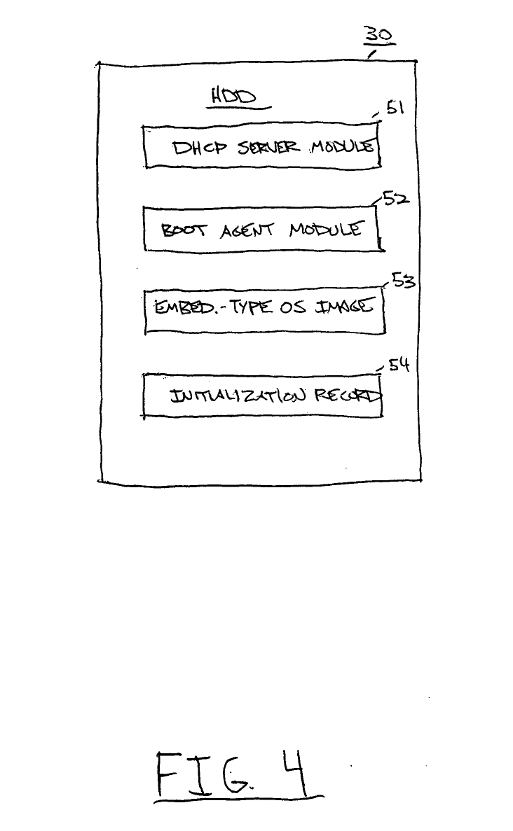

In FIG. 4, the contents of hard disk drive 30 are shown to include DHCP server module 51, boot agent module 52, embedded-type operating system (OS) 53, and initialization record 54. DHCP server module 51 provides functionality for server 10 to act as a DHCP server to assign IP addresses to DHCP clients on LAN 1. Boot agent module 52 is a program image that is sent to intelligent devices, such as intelligent device 15, in order to implement the present invention, and is discussed in more detail below. Embedded-type OS image 53 is an image of an operating system designed for devices with limited resources, such as Microsoft Windows CE or Windows XP Embedded, and is retrieved and loaded by an intelligent device as described more fully below. Embedded-type OS image 53 comprises a file which contains all of the components (kernel image, device drivers, executables, DLLs, etc.) necessary to execute an operating system which is normally embedded in an intelligent device with limited resources. Initialization record 54 is a data file that contains arguments and runtime variables for use by embedded-type OS image 53 when booting in an intelligent device. In this regard, initialization record 54 is also retrieved for use by an intelligent device as described further below.

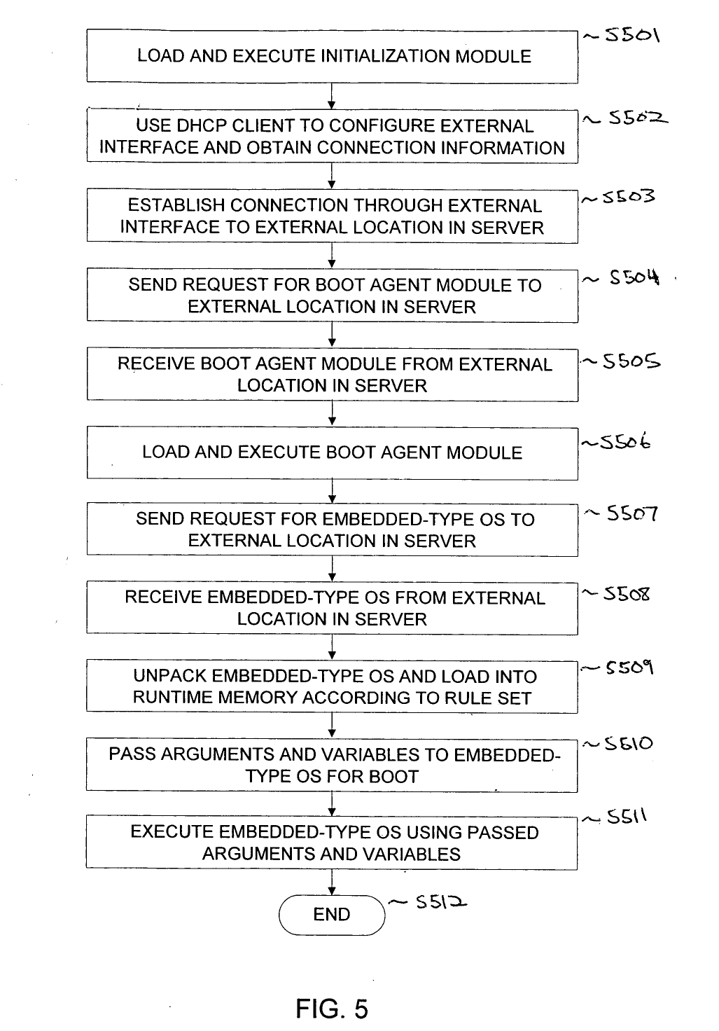

FIG. 5 is a flowchart for explaining the functionality of the present invention, according to one embodiment. Turning to FIG. 5, the process begins at step S501, in which INT18 and/or INT19 of IT18/INT19 modules 41 is read from ROM 22 and executed by CPU 21, preferably at start-up or a cycling of power of intelligent device 15. In this manner, intelligent device 15 is initialized and configured prior to loading and boot of an operating system. INT18 or INT19 maintains process control, and in step S502, DHCP client module 43 is read from ROM 22 and executed by CPU 21 in order to send DHCP requests/events over LAN 1 in order to obtain network information and connection information, such as an IP address, from server 10. The received network information is used to configure external interface 23 for network communication. After external interface 23 is configured, a connection is established between intelligent device 15 and an external location in server 10 via external interface 23 of intelligent device 15 and external interface 34 of server 10 (step S503).

A request is then sent to the external location on hard disk drive 30 of server 10 to retrieve a copy of boot agent module 52 in step S504. In step S505, boot agent module 52 is sent to intelligent device 15 via external interface 23 from server 10. Then, in step S506, boot agent module 52 is loaded into RAM 20 and executed by CPU 21. Boot agent module 52 sends a request to the external location on hard disk drive 30 of server 10 to retrieve a copy of embedded-type OS image 53 in step S507. The copy of embedded-type OS image 53 is sent to intelligent device 15 via external interface 23 from server 10, and is received at intelligent device 15 (step S508).

Once the embedded-type OS image 53 is received by intelligent device 15, boot agent module 52 unpacks embedded-type OS image 53 to obtain a kernel archive, which in the case of Microsoft Windows CE is NK.bin, along with other related data files, and then sub-portions of the kernel archive are loaded into specific locations of RAM 20 in intelligent device 15 (step S509). The unpacking and loading into RAM 20 is performed according to a strict predetermined rule set corresponding to embedded-type OS image 53. Before the loaded portions of embedded-type OS image 53 are executed by CPU 21, they need to have access to specific arguments and runtime variables which will configure the embedded-type OS to operate properly for intelligent device 15.

In this regard, arguments and runtime variables are obtained by retrieving initialization record 54 from hard disk drive 30 of server 10 in response to a request from boot agent module 52. The arguments and runtime variables are then passed to the loaded portions of embedded-type OS image 53 in step S510 by loading them into RAM 20 and providing their address locations. Next, in step S511, the loaded portions of embedded-type OS image 53 are executed by CPU 21 in accordance with the passed arguments and runtime variables. Process control is passed to the executing embedded-type OS, which is thereby made operational in intelligent device 15. The boot process of the present invention is then completed in step S512.

By the foregoing description and related drawings, it can be appreciated that the present invention provides functionality to boot an intelligent device with an embedded-type operating system, such as Windows CE, from a remote location via a network interface, or other data interface. The present invention thereby avoids the need for the intelligent device to have sufficient local memory space to persistently store the operating system. This allows intelligent devices to achieve design and cost savings with respect to the local memory resources and the footprint of the intelligent device. In addition, updates and improvements to the embedded-type operating system can be more easily managed and stored in the server, for subsequent automatic implementation in the intelligent device at boot-up of the device.

The foregoing description of the of the invention has been presented for the purposes of illustration and description, and is not intended to be exhaustive or to limit the scope of the invention to the precise embodiments disclosed herein; It should be appreciated that many modifications, variations and other embodiments of the invention are possible in view of the foregoing description, without departing from the scope or spirit of the invention.

What is claimed is:

1. A system for booting an intelligent device with an embedded-type operating system obtained through an external interface disposed in the intelligent device, the system comprising:
an initialization module stored in a read-only memory provided in the intelligent device, the initialization module being executed in a processor disposed in the intelligent device and connecting to an external location through the external interface; and
a server having a memory media which stores a boot agent module and an embedded-type operating system at the external location, the server sending the boot agent module to the intelligent device through the connection in response to a request from the initialization module,
wherein the boot agent module is loaded into a runtime memory in the intelligent device and executed by the processor, the boot agent module then retrieving an embedded-type operating system image from the external location in the sever, whereupon the embedded-type operating system image is loaded into the runtime memory and executed by the processor.

2. The system of claim 1, wherein execution of the initialization module is initiated by a start-up operation of the intelligent device.

3. The system of claim 1, wherein the connection through the external interface to the external location in the server is established by a DHCP request to the server from the external interface.

4. The system of claim 3, wherein the external interface configures itself based on a response to the DHCP request from the server, and the connection is established by using connection information received from the server in response to a DHCP event sent from the external interface.

5. The system of claim 1, wherein the boot agent module and the embedded-type operating system image are received from the external location in the sever via the connection through the external interface by using a standard connection protocol.

6. The system of claim 5, wherein the external interface is a network interface and the standard connection protocol is the internet protocol, and wherein the intelligent device and the server are connected to a network.

7. The system of claim 5, wherein the external interface is a USB interface and wherein the intelligent device and the server are connected via a USB connection.

8. The system of claim 1, wherein the embedded-type operating system image is loaded into the runtime memory by unpacking the embedded-type operating system image in accordance with a predetermined rule set, and writing particular sub-portions of a kernel archive unpacked from the embedded-type operating system image to corresponding predetermined locations in the runtime memory.

9. The system of claim 8, wherein, once the sub-portions of the kernel archive are written into the runtime memory, a set of arguments and run-time variables, along with process control, are passed to the kernel archive as the kernel archive is executed by the processor.

10. The system of claim 9, wherein an initialization record is used to pass the set of arguments and run-time variables to the kernel archive which is loaded in runtime memory.

11. The system of claim 1, wherein the initialization module is a part of a preboot execution environment supported by the processor.

12. A method for booting an intelligent device with an embedded-type operating system obtained through an external interface disposed in the intelligent device, the method comprising the steps of:
establishing a connection through the external interface to an external location in a server, the server having a memory media which stores a boot agent module and an embedded-type operating system at the external location;
receiving the boot agent module from the server via the connection in response to a request from an initialization module being executed by a processor in the intelligent device;
loading the boot agent module into a runtime memory in the intelligent device and executing the boot agent module with the processor;
receiving, in response to a request from the boot agent module, the embedded-type operating system image from the sever via the connection; and
loading the embedded-type operating system image into the runtime memory and executing the embedded-type operating system image with the processor.

13. The method of claim 12, wherein the establishment of the connection is initiated by a start-up operation of the intelligent device.

14. The method of claim 12, wherein the connection through the external interface to the external location in the server is established by a DHCP request to the server from the external interface.

15. The method of claim 14, wherein the external interface configures itself based on a response to the DHCP request from the server, and the connection is established by using connection information received from the server in response to a DHCP event sent from the external interface.

16. The method of claim 12, wherein the boot agent module and the embedded-type operating system image are received from the external location in the sever via the connection through the external interface by using a standard connection protocol.

17. The method of claim 16, wherein the external interface is a network interface and the standard connection protocol is the internet protocol, and wherein the intelligent device and the server are connected to a network.

18. The method of claim 16, wherein the external interface is a USB interface and wherein the intelligent device and the server are connected via a USB connection.

19. The method of claim 12, wherein the embedded-type operating system image is loaded into the runtime memory by unpacking the embedded-type operating system image in accordance with a predetermined rule set, and writing particular sub-portions of a kernel archive unpacked from the embedded-type operating system image to corresponding predetermined locations in the runtime memory.

20. The method of claim 19, wherein, once the sub-portions of the kernel archive are written into the runtime memory, a set of arguments and run-time variables, along with process control, are passed to the kernel archive as the kernel archive is executed by the processor.

21. The method of claim 20, wherein an initialization record is used to pass the set of arguments and run-time variables to the kernel archive which is loaded in runtime memory.

22. The method of claim 12, wherein the initialization module is a part of a preboot execution environment supported by the processor.

23. Computer-executable process steps stored on a computer readable medium, said computer-executable process steps for booting an intelligent device with an embedded-type operating system obtained through an external interface disposed in the intelligent device, said computer-executable process steps comprising process steps executable to perform a method according to any of claims 12 to 22.
